(19) United States
(12) Patent Application Publication
(10) Pub. No.: US 2020/0269420 A1
(43) Pub. Date: Aug. 27, 2020

(54) KINEMATICS COMPUTATION LIBRARY IMPLEMENTATION SELECTING METHOD, MANIPULATOR CONTROLLING METHOD, KINEMATICS COMPUTATION PROGRAM SELECTING SYSTEM, AND MANIPULATOR CONTROL SYSTEM

(71) Applicant: Preferred Networks, Inc., Tokyo (JP)

(72) Inventors: Ryo Miyajima, Tokyo (JP); Wilson Ko, Tokyo (JP)

(73) Assignee: Preferred Networks, Inc., Tokyo (JP)

(21) Appl. No.: 16/283,524

(22) Filed: Feb. 22, 2019

(51) Int. Cl. B25J 9/16; G06F 8/41

(52) U.S. Cl. CPC B25J 9/1664; B25J 9/1607; B25J 9/163; G06F 8/41

(57) ABSTRACT

A method of selecting a kinematics computation library implementation, includes a first process of compiling, by a first processor, each of a plurality of types of implementations of kinematics computation libraries using different rigid transformation representation formats by a plurality of types of compilers, a second process of performing, by the first processor, each of predetermined kinematics computations by using the plurality of types of implementations of the kinematics computation libraries, which are compiled in the first process, and a third process of comparing, by the first processor, results of the kinematics computations performed in the second process to select an optimum implementation for the predetermined kinematics computation from the plurality of types of implementations of the kinematics computation libraries.

### CROSS-REFERENCE OF RELATED APPLICATION

This application claims the benefit of and priority to Japanese Patent Application No. 2018-031341, filed Feb. 23, 2018, the entire contents of which are incorporated herein by reference.

### FIELD

The present disclosure relates to a method of selecting a kinematics computation library implementation, a method of controlling a manipulator, a system of selecting a kinematics computation program, and a manipulator control system.

### BACKGROUND

For the purpose of causing a manipulator such as a robot arm to perform a high-speed and accurate work, a study is being performed on obtaining a numerical solution of a kinematics problem in an online real-time system (hereinafter, also referred to as kinematics computation). For example, Japanese Patent Publication No. 2005-193311A discloses a control method of a redundant manipulator. In the disclosed method, when a joint is divided into a redundant joint and a non-redundant joint, and a joint angle of the separate redundant joint is changed as a parameter, then, an optimum solution of the joint angle is obtained based on a constraint condition and an evaluation function using the joint angle of the redundant joint given as the parameter and a joint angle of the non-redundant joint obtained as a solution in an inverse kinematics computation. In the disclosed method, it is determined whether the optimum solution covers a target range of the hand end position, and when a negative determination is made, the procedure of obtaining the optimum solution is repeated by changing a target hand end position.

### SUMMARY

It has recently discovered that the speed of kinematics computation greatly contributes to the stability or control accuracy of a manipulator control system, and speeding up is further demanded.

The present disclosure has been made in view of such circumstances, and an object of the present disclosure is to provide a kinematics computation program selecting system, a kinematics computation library implementation selecting method, a manipulator control system, and a manipulator controlling method, in which a kinematics problem may be solved at a high speed.

The present inventors performed intensive studies in order to solve the above described problems, and as a result, they found that an optimum manipulator control program varies according to each architecture of a processor controlling a manipulator. Embodiments of the present disclosure are based on this finding.

In the present disclosure, the term “processor” means hardware (for example, a processor in a robot system) for executing an instruction set described in a software program in a computer system. For example, a processor may refer to processing circuitry of FPGA, a central processing unit (CPU), a graphical processing unit (GPU) or other processing devices implemented on electronic circuits, which can execute an instruction set described in a software program. The term “architecture” means a basic design or a design concept of hardware. In the present specification, the term “performance” means an execution speed, a memory usage amount, or power consumption of a program, and the phrase “most excellent in performance” means the best comprehensively in terms of the execution speed, the memory usage amount, the power consumption and the like. In the present specification, the term “benchmark” means an experimental measurement result as a performance index.

A first aspect of the present disclosure provides a method of selecting a kinematics computation library implementation. The method may include a first process of compiling, by a first processor, each of a plurality of types of implementations of kinematics computation libraries using different rigid transformation representation formats by a plurality of types of compilers, a second process of performing, by the first processor, each of predetermined kinematics computations by using the plurality of types of implementations of the kinematics computation libraries, which are compiled in the first process, and a third process of comparing, by the first processor, results of the kinematics computations performed in the second process to select an optimum implementation for the predetermined kinematics computation from the plurality of types of implementations of the kinematics computation libraries. According to the method, the different rigid transformation representation formats may include at least one of a rigid transformation representation format by a 4×4 matrix or a rigid transformation representation format by quaternions. A method of controlling a manipulator may include performing, by a further processor controlling the manipulator, a kinematics computation that controls a motion of the manipulator by using an implementation selected by the method of selecting a kinematics computation library implementation according to the method of selecting a kinematics computation library implementation. The kinematics computation may be at least one of forward kinematics, inverse kinematics, or a Jacobian matrix.

A second aspect of the present disclosure provides a method of selecting a kinematics computation library implementation. The method may include a first process of optimizing, by a first processor, each of a plurality of types of implementations of kinematics computation libraries using different rigid transformation representation formats, based on architecture of a second processor to be controlled, a second process of compiling, by the first processor, each of the plurality of types of implementations of the kinematics computation libraries, which are optimized in the first process, by a plurality of types of compilers, a third process of performing, by the first processor, each of predetermined kinematics computations by using the plurality of types of implementations of the kinematics computation libraries compiled in the second process, and a fourth process of comparing, by the first processor, results of the kinematics computations performed in the third process, to select an optimum implementation for the second processor and the predetermined kinematics computation from the plurality of types of implementations of the kinematics computation libraries. The different rigid transformation representation formats may include at least one of a rigid transformation representation format by a 4×4 matrix or a rigid transformation representation format by quaternions. In the first process, optimization may be performed according to a vector arithmetic function included in a processor of a robot system. A method of controlling a manipulator may performing, by a further processor controlling the manipulator, a kinematics computation that controls a motion of the manipulator by using an implementation selected by the method of selecting a kinematics computation library implementation according to the method of selecting a kinematics computation library implementation. The kinematics computation may be at least one of forward kinematics, inverse kinematics, or a Jacobian matrix.

A third aspect of the present disclosure provides a system of selecting a kinematics computation program. The system may include a storage device that stores a plurality of types of rigid transformation representation formats, and a first processor. The first processor may be configured to perform a kinematics computation that controls a motion of a manipulator, and select one of the plurality of types of rigid transformation representation formats stored in the storage device by computing each of the plurality of types of rigid transformation representation formats, acquiring performance benchmarks, and selecting, as an optimum rigid transformation representation format, the one rigid transformation representation format that is most excellent in performance by comparing the acquired benchmarks. The first processor may be further configured to optimize an arithmetic function of the optimum rigid transformation representation format according to a further processor controlling the manipulator.

A fourth aspect of the present disclosure provides a manipulator control system including a first processor, a manipulator, a second processor that controls the manipulator, and a storage device that stores a plurality of types of rigid transformation representation formats. The first processor may be configured to perform a kinematics computation that controls a motion of the manipulator, and select one of the plurality of types of rigid transformation representation formats stored in the storage device by computing each of the plurality of types of rigid transformation representation formats, acquiring performance benchmarks, and selecting a rigid transformation representation format that is most excellent in performance by comparing the acquired benchmarks. The first processor may be further configured to optimize an arithmetic function of the optimum rigid transformation representation format according to the second processor.

### Effect

According to some embodiments of the present disclosure, there are provided a kinematics computation library implementation selecting method, a manipulator controlling method, a kinematics computation program selecting system, and a manipulator control system, in which a kinematics problem may be solved at a high speed.

According to some embodiments of the present disclosure in which an optimum program for each architecture of a processor is used so as to solve a kinematics problem at a high speed, for example, the following effects may also be obtained as specific effects.

It is possible to select implementation with a less memory usage amount and/or power saving implementation.

It is possible to speed up data generation for machine learning.

It is possible to enhance the stability of a manipulator control system, thereby enhancing the control accuracy.

### BRIEF DESCRIPTION OF DRAWINGS

FIG. 1 is a block diagram illustrating a configuration of a manipulator control system according to some embodiments;

FIG. 2 is a flow chart when a forward kinematics computation and/or a Jacobian kinematics computation is executed according to some embodiments;

FIG. 3 is a flow chart when a kinematics computation for inverse kinematics is executed according to some embodiments;

FIG. 4 is a flow chart used when a kinematics computation program is compiled according to some embodiments; and

FIG. 5 is a graph indicating a comparison between kinematics computation speed results in a manipulator controlling method according to according to some embodiments and a method in the related art, respectively.

### DETAILED DESCRIPTION

<Kinematics Computation Program Selecting System, Manipulator Control System>

A kinematics computation program selecting system according to some embodiments of the present disclosure may include a storage device that stores a plurality of types of rigid transformation representation formats, a kinematics computation unit that performs a kinematics computation that controls a motion of a manipulator to be controlled, and a rigid transformation representation format selector that selects any one of the plurality of types of rigid transformation representation formats stored in the storage device. The rigid transformation representation format selector may have a function of computing each of the plurality of types of rigid transformation representation formats by the kinematics computation unit, acquiring performance benchmarks, and selecting a rigid transformation representation format that is most excellent in performance by comparing the acquired benchmarks.

A manipulator control system according to some embodiments of the present disclosure may include a combination of the above described kinematics computation program selecting system and a robot system including a manipulator to be controlled.

Hereinafter, descriptions will be made on a kinematics computation program selecting system and a manipulator control system according to some embodiments of the present disclosure. However, the present disclosure is not limited by the embodiments described in the present disclosure.

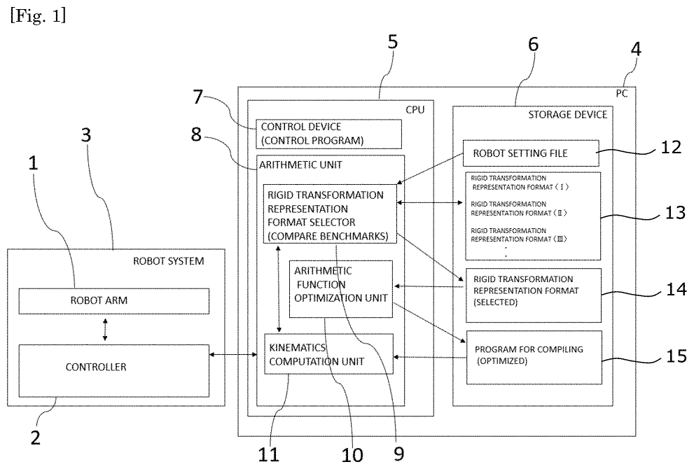

The manipulator control system according to some embodiments, as illustrated in FIG. 1, may include a robot system 3 and a computer 4. The robot system 3 may include a manipulator (e.g., a robot arm) 1 to be controlled and a processor 2 that controls the manipulator. The computer 4 may transmit and receives control signal to/from the robot system 3. The computer 4 may include a CPU 5 and a storage device 6. The CPU 5 may include a control device 7 and an arithmetic unit 8.

The storage device 6 may implement and store a plurality of types of rigid transformation representation formats 13. As the type of a rigid transformation representation format, for example, a rigid transformation representation format by a 4×4 matrix, a rigid transformation representation format by quaternions, a homogeneous transformation matrix, quaternions, and a combination of a rotation matrix and a translation vector may be exemplified. Implementation may be made by combining those provided as existing libraries. A combination of a plurality of types of rigid transformation representation formats is not particularly limited, and the types may be properly recombined for use depending on applications.

The arithmetic unit 8 may include a rigid transformation representation format selector 9, an arithmetic function optimization unit 10, and a kinematics computation unit 11.

The rigid transformation representation format selector 9 may have a function of compiling each of the plurality of types of rigid transformation representation formats implemented and stored in the storage device 6 into the kinematics computation unit 11, acquiring performance benchmarks, and selecting a rigid transformation representation format that is most excellent in the performance by comparing the acquired benchmarks. In some embodiments, the rigid transformation representation format selector 9 may read information on a robot system from a robot setting file 12 and select a rigid transformation representation format based on the robot system information and results of the benchmarks.

Until now, although it has not been proposed to select an optimum rigid transformation representation format in consideration of a unique instruction set (e.g., instruction set for a single instruction, multiple data https://www.google.com/imgres?imgurl=https://upload.wikimedia.org/wikipedia/commons/thrumb/c/ce/SIMD2.svg/1200px-SIMD2.svg.png&imgrefurl=https://en.wikipedia.org/wiki/SIMD&h=1235&w=1200&tbnid=xDpU0bS7qYuM2M:&q=SIMD&tbnh=160&tbnw=155&usg=AI4-kReUrWjAtP87tY3XI2BWlvM3u2HlA&vet=1&docid=m1Olzt_dtFpUGM&sa=X&bed=2ahUKEwj--vydgpngAhVJ7YMKHbpQCYYQ9QEwAHoECAYQBg (SIMD) optimization) included in a CPU, when a corresponding problem is raised, it is generally considered that a method of predicting an optimum rigid transformation representation format based on architecture of a processor is employed. However, since architecture of a processor is recently becoming complicated, it is difficult to determine a rigid transformation representation format optimized for a processor, by prediction based on a theory. In some embodiments of the present disclosure, it is possible to select an optimum rigid transformation representation format by a method of acquiring and comparing benchmarks.

The arithmetic function optimization unit 10 may have a function of further optimizing the arithmetic function of an optimum rigid transformation representation format 14 selected by the rigid transformation representation format selector 9, according to a processor (e.g., the processor 2 of the robot system 3).

An optimization method used by the arithmetic function optimization unit 10 is not particularly limited. For example, a method of using Streaming SIMD Extensions (SSE) Intrinsics for x86-based architecture (provided by Intel Corporation) may be used, which performs SIMD optimization using a library (e.g., Eigen) by which SIMD (e.g., a vector arithmetic function included in a CPU) optimization is implemented.

Depending on architecture of a processor or a combination of compilers to be used, in some cases, there may be no large difference in performance before and after optimization. However, in many cases, it is possible to greatly improve the performance through a corresponding process.

At least one or more of the control device 7, the rigid transformation representation format selector 9, the arithmetic function optimization unit 10, and the kinematics computation unit 11 (of the arithmetic unit 8) may be implemented with a special circuit (e.g., processing circuitry of a FPGA or the like), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like.

<Kinematics Computation Library Implementation Selecting Method, Manipulator Controlling Method>

A kinematics computation library implementation selecting method according to some embodiments of the present disclosure may be executed by the above-described kinematics computation program selecting system. The kinematics computation library implementation selecting method according to some embodiments of the present disclosure may include a first process of compiling each of a plurality of types of implementations of kinematics computation libraries using different rigid transformation representation formats by a plurality of types of compilers, a second process of performing each of predetermined kinematics computations by using the plurality of types of implementations of the kinematics computation libraries, which are compiled in the first process, and a third process of comparing results of the kinematics computations performed in the second process to select an optimum implementation for the predetermined kinematics computation from the plurality of types of implementations of the kinematics computation libraries. In some embodiments of the present disclosure, the kinematics computation library implementation selecting method may include a first process of optimizing each of a plurality of types of implementations of kinematics computation libraries using different rigid transformation representation formats, based on architecture of a processor, a second process of compiling each of the plurality of types of implementations of the kinematics computation libraries, which are optimized in the first process, by a plurality of types of compilers, a third process of performing each of predetermined kinematics computations by using the plurality of types of implementations of the kinematics computation libraries compiled in the second process, and a fourth process of comparing results of the kinematics computations performed in the third process, to select an optimum implementation for the processor and the predetermined kinematics computation from the plurality of types of implementations of the kinematics computation libraries.

A manipulator controlling method according to some embodiments of the present disclosure may include a step of using the implementation selected by the above-described kinematics computation library implementation selecting method, for a kinematics computation that controls a motion of a manipulator to be controlled.

In the manipulator controlling method according to some embodiments, the present disclosure, a kinematics computation for at least one of forward kinematics, inverse kinematics, or Jacobian matrix may be performed by a program for compiling (e.g., a program for compiling 15 in FIG. 1).

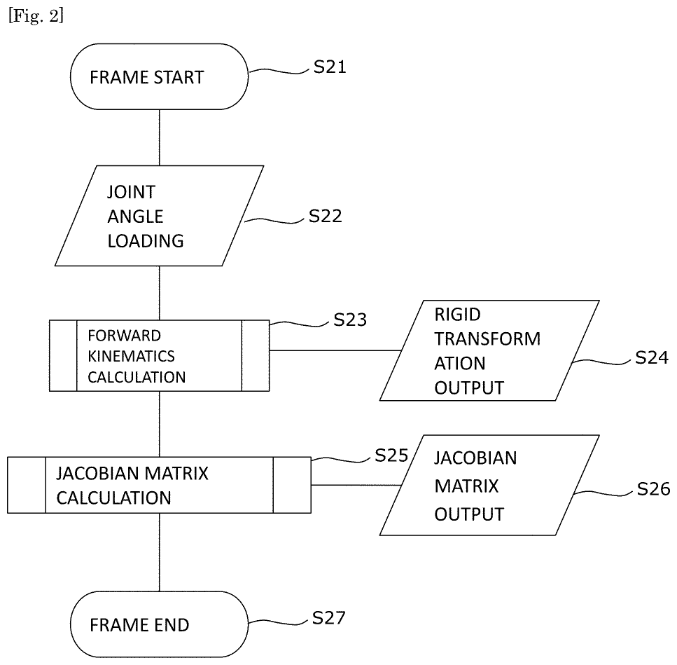

In some embodiments, when the program for compiling is for a forward kinematics computation and/or a Jacobian kinematics computation, the kinematics computation may be executed according to the flow chart illustrated in FIG. 2. Referring to FIG. 2, when processing of a frame starts (S21), joint angle loading may be performed (S22). Next, a forward kinematics calculation may be performed (S23) and a result of rigid transformation may be output (S24). Next, a Jacobian matrix calculation may be performed (S25), a Jacobian matrix may be output (S26), and the processing of the frame ends (S27).

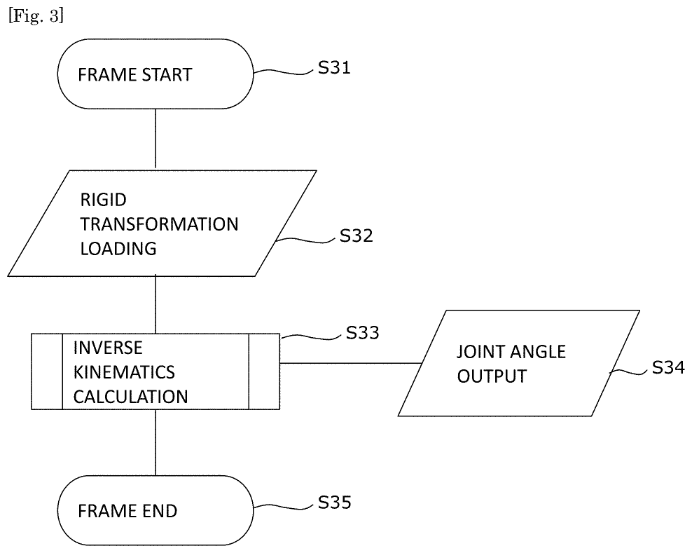

In some embodiments, when the program for compiling is for a kinematics computation for inverse kinematics, the kinematics computation may be executed according to the flow in FIG. 3. Referring to FIG. 3, when processing of a frame starts (S31), rigid transformation loading may be performed (S32). Next, an inverse kinematics calculation may be performed (S33), a joint angle may be output (S34), and the processing of the frame ends (S35).

In some embodiments, the program for compiling may be optimized according to the architecture of a processor controlling a manipulator, thereby it is possible to increase the speed of the kinematics computation executed after compiling.

Hereinafter, Examples will be described, and the present disclosure will be described in more detail.

### Computation Example A

With respect to two types of kinematics computation libraries (MAT4 and QUAT) using different rigid transformation representation formats, in a case where optimization was performed with Eigen (described as MAT4(E) and QUAT(E), respectively, in Table 1), and in a case where optimization was not performed, kinematics computations were carried out with following combinations of four types of CPUs (Cortex-M3, ARMv7, i5-7500, and i7-6700K) and two types of compilers (gcc and clang), respectively, and the computation speeds were examined. The results are noted in Table 1. MAT4 is a rigid transformation representation format using a 4×4 matrix, and QUAT is a rigid transformation representation format using quaternions.

TABLE 1
TABLE I
THE EXECUTION TIME AMONG DIFFERENT IMPLEMENTATION
VARIANTS IN MICROSECONDS (CORTEX-M3) AND
NANOSECONDS (ARMv7, I5-7500, I7-6700K).
ALL RESULTS ARE FOR 100 ITERATIONS.

| | CPU | | | | | |
|---|---|---|---|---|---|---|
| | Cortex-M3 | ARMv7 | i5-7500 | | i7-6700K | |
| | Compiler | | | | | |
| | gcc | gcc | gcc | clang | gcc | clang |
| MAT4(E) | 12776 | 17422 | 541 | 511 | 492 | 460 |
| MAT4 | 12713 | 35083 | 2206 | 2251 | 1996 | 2030 |
| QUAT(E) | 3249 | 3038 | 197 | 190 | 180 | 173 |
| QUAT | 3241 | 3025 | 490 | 454 | 438 | 410 |

From Table 1, it may be confirmed that in i5-7500 and i7-6700K, for both MAT4 and QUAT, a kinematics computation speed is increased by 50% or more when optimization is performed with Eigen. In ARMv7, for MAT4, it may be confirmed that a kinematics computation speed is increased by 50% or more when optimization is performed with Eigen.

In combinations of Cortex-M3 and MAT4, Cortex-M3 and QUAT, and ARMv7 and QUAT, it cannot be confirmed that a kinematics computation speed is increased through optimization with Eigen. However, this means that prior to optimization with Eigen, a rigid transformation representation format has already become a format with which high performance is implementable.

From the above results, it may be confirmed that high performance can be implemented regardless of architecture by incorporating an optimization process with Eigen prior to compiling of a program.

### Computation Example B

With respect to three types of kinematics computation libraries (MAT3, MAT4, and DQ) using different rigid transformation representation formats, in a case where optimization was performed with Eigen, kinematics computations were carried out with following combinations of four types of CPUs (Cortex-M3, ARMv7, i5-7500, and i7-6700K) and two types of compilers (gcc and clang), respectively, and examination results of the computation speeds are noted in Table 2.

TABLE 2
TABLE II
THE EXECUTION TIME AMONG DIFFERENT IMPLEMENTATION
VARIANTS IN MICROSECONDS (CORTEX-M3) AND
NANOSECONDS (ARMv7, I5-7500, I7-6700K).
ALL RESULTS ARE FOR 100 ITERATIONS.

| | CPU | | | | | |
|---|---|---|---|---|---|---|
| | Cortex-M3 | ARMv7 | i5-7500 | | i7-6700K | |
| | Compiler | | | | | |
| | gcc | gcc | gcc | clang | gcc | clang |
| MAT3 | 7220 | 9888 | 990 | 1227 | 814 | 1105 |
| MAT4 | 12776 | 17422 | 541 | 511 | 492 | 460 |
| DQ | 10116 | 9467 | 590 | 564 | 538 | 508 |

From Table 2, it may be confirmed that in a rigid transformation representation format with which a kinematics computation may be implemented at the highest speed, combinations of four types of CPUs (Cortex-M3, ARMv7, i5-7500, and i7-6700K) and two types of compilers (gcc and clang) are different from each other.

From the above results, it may be confirmed that in a case where the selection of a rigid transformation representation format similar to that in some embodiments of the present disclosure is not made, even when optimization is performed with Eigen, it is not possible to stably implement high performance.

### Computation Example C

With respect to three types of kinematics computation libraries (MAT3, MAT4, and DQ) using different rigid transformation representation formats, after optimization was performed with Eigen, kinematics computations were carried out with following combinations of four types of CPUs (Cortex-M3, ARMv7, i5-7500, and i7-6700K) and two types of compilers (gcc and clang), respectively, for each of a forward motion, an inverse motion, and a Jacobian matrix. Then, examination results of the computation speeds, and examination results of the computation speeds after similar kinematics computations were carried out using the existing representative kinematics computation library Orocos KDL are noted in Table 3.

TABLE 3
TABLE III
THE EXECUTION TIME COMPARISON AGAINST KDL IN
MICROSECONDS (CORTEX-M3) AND NANOSECONDS
(ARMv7, I5-7500, I7-6700K). WE RAN
THE TESTS FOR A SERIAL CHAIN
OF SEVEN REVOLUTE JOINTS.

| Target | Method | Cortex-M3 | ARMv7 | i5-7500 | i7-6700K |
|---|---|---|---|---|---|
| Forward | MAT3 | 936 | 1267 | 245 | 180 |
| | MAT4 | 1416 | 1704 | 284 | 223 |
| | DQ | 512 | 1283 | 209 | 161 |
| | KDL | 900 | 5457 | 396 | 294 |
| Jacobian | MAT3 | 1100 | 3376 | 487 | 361 |
| | MAT4 | 1600 | 3813 | 493 | 373 |
| | DQ | 1628 | 3845 | 704 | 541 |
| | KDL | 2050 | 13392 | 1215 | 926 |
| Inverse | MAT3 | 10323 | 41840 | 5603 | 4319 |
| | MAT4 | 10813 | 42399 | 5614 | 4311 |
| | DQ | 10798 | 42062 | 5811 | 4457 |
| | KDL | 18744 | 95510 | 15237 | 11805 |

From Table 3, it may be confirmed that in a case where optimization is performed with Eigen with respect to three types of kinematics computation libraries (MAT3, MAT4, and DQ), a kinematics computation speed is remarkably faster in 35 examples out of 36 examples (all except for a forward motion in Cortex-M3) as compared to that in a case where KDL is used. Meanwhile, it may be confirmed that even for the same CPU, an optimum kinematics computation library is different between types (a forward motion, an inverse motion, and a Jacobian matrix) of a kinematics computation.

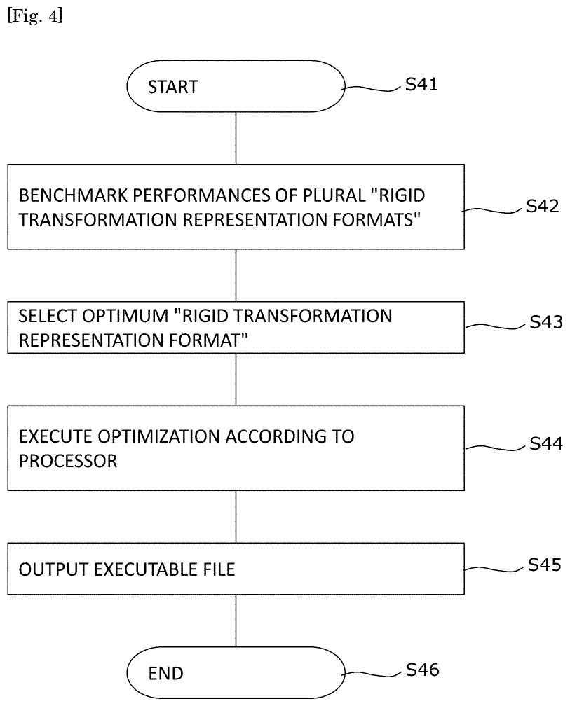

FIG. 4 is a flow chart used when a kinematics computation program is compiled according to some embodiments. Referring to FIG. 4, when processing of the kinematics computation program starts (S41), performance benchmark on plural rigid transformation representation formats (e.g., rigid transformation representation formats 13 in FIG. 1) may be performed (S42). Next, an optimum rigid transformation representation format may be selected (e.g., selected rigid transformation representation format 14 in FIG. 1). Next, an optimization according to a process may be executed (S43), an executable file may be output (S44) and the processing of the kinematics computation program ends (S46).

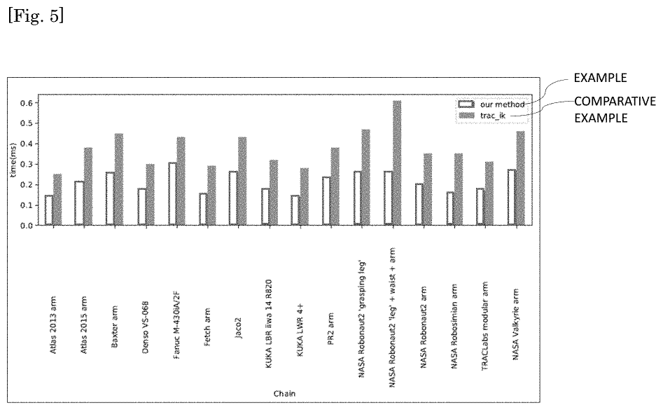

With respect to 16 types of robots as targets, kinematics computations were carried out, in which the flow in FIG. 4 was applied when a kinematics computation program that performs a kinematics computation for inverse kinematics was compiled. Then, computation speeds were measured. The results of the measurement are denoted by Example in FIG. 5.

On the other hand, with respect to the same targets as above, kinematics computations were carried out, in which trac_ik as an existing program for performing a kinematics computation for inverse kinematics was uniformly applied. Then, computation speeds were measured. The results of the measurement are denoted by Comparative Example in FIG. 5.

From FIG. 5, according to some embodiments of the present disclosure, it may be confirmed that for all the 16 types of robots, a kinematics computation time is shortened to 80% or less, that is, a kinematics computation speed is increased by 20% or more, as compared to that in a case where trac_ik runs is uniformly applied (a method in the related art).

### INDUSTRIAL APPLICABILITY

The present disclosure is applicable to controlling any one of a position, a speed, and a force of the whole of a robot using a rigid body model such as a robot arm or a robot hand. This is applicable to not only a rotating joint angle but also a linear motion joint. The present disclosure is also applicable to matrix transformation such as 3DCG.

1. A method of selecting a kinematics computation library implementation, the method comprising:
a first process of compiling, by a first processor, a plurality of types of kinematics computation libraries using different rigid transformation representation formats by a plurality of types of compilers;
a second process of performing, by the first processor, a kinematics computation by using the plurality of types of kinematics computation libraries, which are compiled in the first process; and
a third process of comparing, by the first processor, results of the kinematics computation performed in the second process to select an optimum implementation for the kinematics computation from the plurality of types of kinematics computation libraries.

2. The method of selecting the kinematics computation library implementation according to claim 1, wherein the different rigid transformation representation formats include at least one of a rigid transformation representation format by a 4×4 matrix or a rigid transformation representation format by quaternions.

3. A method of controlling a manipulator, comprising:
performing, by a further processor controlling the manipulator, a kinematics computation that controls a motion of the manipulator by using an implementation selected by the method of selecting the kinematics computation library implementation according to claim 1.

4. The method of controlling the manipulator according to claim 3, wherein the kinematics computation is at least one of forward kinematics, inverse kinematics, or a Jacobian matrix.

5. A method of selecting a kinematics computation library implementation, the method comprising:
a first process of optimizing, by a first processor, a plurality of types of kinematics computation libraries using different rigid transformation representation formats, based on architecture of a second processor to be controlled;
a second process of compiling, by the first processor, the plurality of types of kinematics computation libraries, which are optimized in the first process, by a plurality of types of compilers;
a third process of performing, by the first processor, a kinematics computation by using the plurality of types of kinematics computation libraries compiled in the second process; and
a fourth process of comparing, by the first processor, results of the kinematics computation performed in the third process, to select an optimum implementation for the second processor and the kinematics computation from the plurality of types of kinematics computation libraries.

6. The method of selecting the kinematics computation library implementation according to claim 5, wherein the different rigid transformation representation formats include at least one of a rigid transformation representation format by a 4×4 matrix or a rigid transformation representation format by quaternions.

7. The method of selecting the kinematics computation library implementation according to claim 5, wherein in the first process, optimization is performed according to a vector arithmetic function included in a processor of a robot system.

8. A method of controlling a manipulator, comprising:
performing, by a further processor controlling the manipulator, a kinematics computation that controls a motion of the manipulator by using an implementation selected by the method of selecting the kinematics computation library implementation according to claim 5.

9. The method of controlling the manipulator according to claim 8, wherein the kinematics computation is at least one of forward kinematics, inverse kinematics, or a Jacobian matrix.

10. A system of selecting a kinematics computation program, the system comprising:
a storage device that stores a plurality of types of rigid transformation representation formats; and
a first processor configured to
perform a kinematics computation that controls a motion of a manipulator; and
select one of the plurality of types of rigid transformation representation formats stored in the storage device by computing the plurality of types of rigid transformation representation formats, acquiring performance benchmarks, and selecting, as an optimum rigid transformation representation format, the one rigid transformation representation format that is most excellent in performance by comparing the acquired benchmarks.

11. The system of selecting the kinematics computation program according to claim 10, wherein the first processor is further configured to optimize an arithmetic function of the optimum rigid transformation representation format according to a further processor controlling the manipulator.

12. A manipulator control system comprising:
a first processor;
a manipulator;
a second processor that controls the manipulator; and
a storage device that stores a plurality of types of rigid transformation representation formats,
wherein the first processor is configured to
perform a kinematics computation that controls a motion of the manipulator,
select one of the plurality of types of rigid transformation representation formats stored in the storage device by computing the plurality of types of rigid transformation representation formats, acquiring performance benchmarks, and selecting the one rigid transformation representation format that is most excellent in performance by comparing the acquired benchmarks.

13. The manipulator control system according to claim 12, wherein
the first processor is further configured to optimize an arithmetic function of the optimum rigid transformation representation format according to the second processor.
